(19) United States
(12) Patent Application Publication
(10) Pub. No.: US 2006/0229178 A1
(43) Pub. Date: Oct. 12, 2006

(54) Method and device for spreading triacetin onto a filter material web

(75) Inventors: Stephan Wolff, Glinde (DE); Michael Straube, Hamburg (DE); Reimund Boenisch, Moelln (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/397,575

(22) Filed: Apr. 5, 2006

(30) Foreign Application Priority Data
Apr. 6, 2005 (DE) 10 2005 015 877.3

(51) Int. Cl. B31C 13/00

(52) U.S. Cl. 493/49; 493/39

(57) ABSTRACT

Method and device for spreading an additive onto a moving filter material web of the tobacco-processing industry, and an apparatus for preparing filter material webs of the tobacco-processing industry including the device. The method includes warming the additive with at least one heating device, monitoring a heating output of the at least one heating device, and spreading the additive with at least one spreading element. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2005 015 877.3, filed on Apr. 6, 2005, the disclosure of which is expressly incorporated by reference herein in its entirety.

### BACKGROUND OF THE INVENTION

1. Field of the Invention

The invention relates to a method and a device for spreading a preferably liquid additive onto a moving filter material web of the tobacco-processing industry with at least one spreading element, whereby the additive is warmed by a heating device. The invention further relates to an apparatus for preparing filter material webs of the tobacco-processing industry and to a use of a cartridge heater.

2. Discussion of Background Information

During the production of filter rods for the tobacco-processing industry, filter tow generally made of cellulose acetate is pulled from a supply as a running web and is treated. The filter tow is made of a woven material of threads loosely adhering to one another which are pulled apart in order to form a wide and mostly level web such that the threads are moved next to one another and essentially parallel. The web is expanded in an expander nozzle. Following the expansion, an additive is supplied to the web in finely dispersed form, which additive is typically liquid and made of, e.g., triacetin droplets. The droplets start to dissolve the threads such that the threads permanently stick together, i.e., are interlaced after having been gathered to form a round rod and encased with a filter paper strip in a filter rod-making machine. An additive made of a finely dispersed powdery substance can also be used in place of a liquid additive. Preparation equipment of the type described above is described in the patent documents U.S. Pat. No. 5,060,664 and U.S. Pat. No. 4,511,420.

It is known from DE-A-199 59 034 to spray plasticizer onto filter tow with the aid of a row of nozzles arranged transverse to the movement direction of the filter tow. Hereby, the individual nozzles are controlled with upstream sensors that record the density of the filter tow in the respective sections.

It is vitally important for the quality of the preparation that the individual threads or fibers are well separated and/or that the finely dispersed plasticizer particles are permanently spread evenly in the form of droplets or fine particles.

DE-A40 03 051 further describes an apparatus for spreading plasticizers onto a filter tow strip to produce cigarette filters, whereby a heating device is provided for warming the plasticizer to a preset temperature before its application to the filter tow strip. PTC thermistor elements are hereby provided as heating elements which warm the plasticizer in such a temperature range that the plasticizer is applied and processed at an optimum temperature. The temperature of the plasticizer has an influence on the spreading conditions of the plasticizer and the reactivity of the plasticizer with the tow material.

### SUMMARY OF THE INVENTION

The present invention increases production reliability when spreading triacetin onto a filter material strip.

According to the invention, a method is provided for spreading a preferably liquid additive onto a moving filter material web of the tobacco-processing industry with at least one spreading element. The additive is warmed by a heating device which is further developed in that the heating output of the heating device is monitored.

The invention is based on the concept that the viscosity of the additive to be spread, e.g., triacetin, depends on the temperature. On the basis of the absorbed heating output of the heating device for warming the additive it is possible to determine whether a spreading nozzle or a spreading element is clogged or remains operational. If, for instance, too little heating output is determined, a corresponding nozzle may be clogged. A simple monitoring of the operation of the spraying system is thus achieved when triacetin is spread onto a conveyed filter tow strip. The embodied monitoring of the heating output simultaneously improves the quality of the triacetin spreading onto the conveyed filter tow strip, as the operational reliability of the spreading system is monitored on the basis of the determined heating output.

In particular, the heating outputs of several heating devices are monitored, since the additive is warmed, for instance by a heating device, for one or more spreading elements, e.g., spreading nozzles.

According to an advantageous further development the recorded heating outputs as actual values are compared to a predetermined set value. A reliable monitoring of production reliability is thus ensured. For example, the set value is or will be preset such that an optimum spreading of triacetin onto a filter tow strip is embodied. The set value can also be determined dynamically or be based on empirical findings. In a dynamic development of the set value the temporal changes of the heating outputs during the operation of the spreading system are monitored and, e.g., averaged.

It is further advantageous if the set value is identified as the mean value of the heating outputs of several heating devices. Given the potential fluctuations of the absorbed heating outputs, a dynamic and continuous adaptation of the set value is thus achieved. The mean value of the set value can be established, e.g., by averaging the heating outputs over all heating devices.

In a further alternative, average determination the (lower and upper) extreme values of the heating outputs are excluded from the averaging. For this, the set value is identified as the mean value of the heating outputs of several heating devices, excluding the maximum heating output of a heating device and the minimum heating output of a heating device.

In addition, an alarm message is advantageously produced and/or displayed at a predetermined difference between an actual value of the heating output of a heating device and the set value, so that the operating personnel are informed that fluctuations in the spreading of triacetin occurred or are occurring at one or more spreading nozzles. In this manner, fluctuations at which an essentially even spreading of triacetin is sufficiently ensured are still within a tolerance range.

If the actual values lie outside the tolerance range, it is suggested according to an advantageous further development that the spreading of the additive is interrupted at a predetermined (second) difference between an actual value of the heating output of a heating device and the set value. Production is thus stopped in order to search for malfunctions of the spreading system or the spreading nozzles and, if necessary, fix the malfunction by cleaning pipes or exchanging a spreading nozzle. At the same time, the production stop reduces rejects of defective filter rods or sections of filter rods.

An even spreading of the additive is achieved if the additive is sprayed onto the filter material web by means of at least one nozzle. The spreading is further improved if there are several nozzles.

In addition, it is advantageous if the additive for one nozzle is respectively warmed by one heating device. In this case, one heating device is assigned to exactly one nozzle.

In particular the additive is warmed by a PTC thermistor of the heating device or a cartridge heater. The use of PTC thermistors as heating elements ensures that an overheating of a plasticizer and, potentially, an ignition of the plasticizer are ruled out. The PTC thermistor used as heating element is chosen such that the maximum temperature to be achieved at the applied voltage remains sufficiently far below the flashpoint of the plasticizer. The use of a PTC thermistor as heating element, e.g., in a cartridge heater results in that, as the temperature rises, the electric resistance of the heating element increases so far that the heating temperature does not reach the flashpoint of the plasticizer. PTC thermistor elements are also called PTC heating elements, whereby the resistance changes with the temperature of the material. The resistance of a PTC thermistor increases with a rise in temperature. PTC thermistors thus have a so-called positive temperature coefficient.

Furthermore, triacetin is advantageously spread onto the filter material web as an additive. Triacetin has proved to be a suitable plasticizer and curing agent in the production of filter rods.

The present invention provides a device for spreading a preferably liquid additive onto a moving filter material web of the tobacco-processing industry with a spreading element. A heating device for the additive is provided which is further developed in that a device for monitoring the heating output of the heating device is provided.

According to a preferred further development, it is suggested that the device for monitoring the heating output features a measuring arrangement, so that the heating outputs of the heating device or the heating devices are recorded in a simple manner.

If several heating devices are provided, it is advantageous if the measuring arrangement features several measuring devices for measuring the heating outputs.

It is further favorable if the measuring arrangement features a processor unit and/or a display, so that the recorded measurement data can be compared to one another with regard to the heating output and stored. The display serves to display alarm messages or the indication of a defective spreading nozzle.

It is further preferred if one heating device is provided for respectively one spreading element.

The heating device is embodied in particular by a PTC thermistor or as a cartridge heater.

Furthermore, at least one nozzle is provided as a spreading element for applying the additive to the filter material. In this way, the at least one nozzle can be charged with a constant pressure in order to ensure an even spreading of the additive, in particular, triacetin.

The invention provides an apparatus for preparing filter material webs of the tobacco-processing industry, which is furnished with a device according to the invention described above. To prevent repetitions, express reference is made to the above statements regarding the spreading device.

The invention uses a cartridge heater or a so-called “oil preheater” in a device of the type described above. An oil preheater is known, e.g., from Danfoss under the name “FPHB 3.” This oil preheater is furnished with a PTC heating element. According to the invention, the heating output of the PTC element as heating element or heating device for the additive or the triacetin is monitored, so that an even spreading of triacetin onto a moving filter tow strip is achieved.

The present invention is directed to a method for spreading an additive onto a moving filter material web of the tobacco-processing industry. The method includes warming the additive with at least one heating device, monitoring a heating output of the at least one heating device, and spreading the additive with at least one spreading element.

According to a feature of the invention, the additive can be a liquid additive.

In accordance with another feature of the present invention, the at least one heating device may include multiple heating devices, and the heating outputs of a plurality of the multiple heating devices can be monitored. The method can also include comparing actual values of the heating outputs to a set value, where the set value can be identified as a mean value of the heating outputs of the plurality of heating devices. Further, the set value may be identified as a mean value of the heating outputs of the plurality of heating devices excluding the maximum heating output and the minimum heating output of the plurality of heating devices. The method may also include, in response to detecting a predetermined difference between the actual value of the heating output of one of the multiple heating devices and the set value, at least one of producing and displaying an alarm message. Moreover, in response to detecting a predetermined difference between the actual value of the heating output of one of the multiple heating devices and the set value, the process may include interrupting the spreading of the additive.

According to still another feature of the instant invention, the additive can be sprayed onto the filter material web by at least one nozzle. The additive for each nozzle may be respectively warmed by one heating device.

In accordance with the method, the additive can be warmed by at least one of a PTC thermistor of the heating device and a cartridge heater.

In accordance with still another feature of the invention, the additive can include triacetin.

The present invention is directed to a device for spreading an additive to a moving filter material web of the tobacco-processing industry. The device includes a spreading element, at least one heating device structured and arranged to heat the additive, and a monitor device structured and arranged to monitor a heating output of the at least one heating device.

According to the invention, the additive can be a liquid additive.

Moreover, the monitor device may include a measuring arrangement, and the measuring arrangement can include a plurality of measuring devices structured and arranged to measure the heating outputs. Additionally or alternatively, the measuring arrangement may also include at least one of a processor unit and a display.

In accordance with a feature of the invention, the spreading element can include spreading devices and the at least one heating device may include heating devices, such that one heating device can be respectively associated with each spreading device.

According to another feature of the invention, the heating device can include one of a PTC thermistor and a cartridge heater.

In accordance with still yet another feature of the present invention, the spreading element can include at least one nozzle.

The instant invention is directed to an apparatus for preparing filter material webs of the tobacco-processing industry comprising the above-discussed device.

The present invention is directed to a process of supplying an additive to a web in the above-discussed device, in which the process includes heating the additive with the at least one heating device composed of a cartridge heater, monitoring the heating output of the cartridge heater, and supplying the heated additive to the spreading element.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a cross-sectional view of a spreading device;

FIGS. 2a and 2b respectively illustrate a perspective sectional view of the device depicted in FIG. 1; and

FIG. 3 illustrates a diagrammatic view of spreading nozzles with a measurement arrangement.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

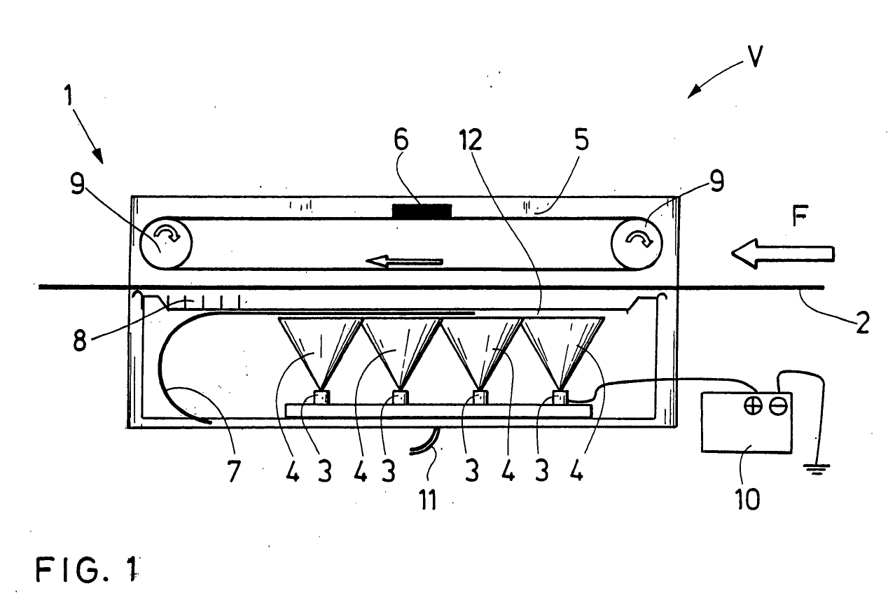

FIG. 1 shows a device 1 for spreading a plasticizer, e.g., triacetin, onto a flatly expanded filter tow 2 or onto a filter material strip. Filter tow 2 is transported from the right side to the left side in accordance with conveying direction F.

Device 1 is part of a diagrammatically indicated filter tow preparation apparatus V of the tobacco-processing industry. Such an apparatus by the assignee of the instant invention is known, e.g., under the name “AF2,” “AF3” or “AF4.”

Spray nozzles 3 are arranged in the lower region of device 1 at a predetermined distance from one another. Spray nozzles 3 respectively produce a fine spray cone 4. Spray nozzles 3 are preferably arranged in an equidistant manner and in the same plane to produce an even and constant spray pattern. A fine fog-like hollow cone of atomized plasticizer is obtained with spray nozzles 3. In particular so-called “axial hollow cone nozzles” are suitable for this.

Spray nozzles 3 are supplied with a uniform system pressure by one or more supply sources to ensure an optimum droplet size and droplet speed. Spray cones 4 can overlap for the resulting spray pattern. Spray nozzles 3 are arranged below filter tow 2 and spray from below onto filter tow 2 that is conveyed past. A displaceable, and in particular motor-driven, covering sheet 7 is arranged between spray nozzles 3 and filter tow 2 such that the spray area of spray cones 4 is delimited and the plasticizer is spread over a spreading area 12. Furthermore, the size of spreading area 12 can be varied. The size of spreading area 12 can be increased or reduced, depending on the kind of use, the filter tow type and/or the filter tow amount. In this manner, spray nozzles 3 continue to be charged at a constant feed pressure. On the whole, this produces a constant spray pattern.

Furthermore, a voltage source 10, in particular a high-voltage source, is provided to administer a charge to the spray particles in order to achieve a better adhesion of the plasticizer particles of spray fog 4 to filter tow 2. Applying electrical charges to filter tow 2 is disclosed, for example, in German patent document DE-A-42 09 606.

Displaceable covering sheet 7 is used to control the amount of plasticizer spread onto filter tow 2 by covering more or less spray area of spray cones 4, depending on the requirements. Covering sheet 7 is embodied, e.g., as a flexible metal sheet and is moved in the tow direction with the aid of a motor and/or a spindle.

A circulating belt 5 that circulates over rollers 9 is embodied above filter tow 2 over the complete length of device 1. With the surface of belt 5 facing filter tow 2, belt 5 picks up the plasticizer not picked up by filter tow 2. Following a deflection, belt 5 is guided along below a stripping edge 6 in order to remove the excess triacetin on belt 5. The speed of belt 5 is thereby preferably below the limit at which a drop of the plasticizer would fall off during the deflection. The belt speed is therefore preferably considerably below the filter tow speed. Spray fog barriers 8 are arranged parallel to one another at the outlet of device 1 to allow as little plasticizer as possible to escape from device 1. Device 1 is preferably provided with a housing.

The plasticizer amount picked up by belt 5 is stripped off with the aid of stripping edge 6 arranged transverse to belt 5. In the process, the plasticizer liquid is again deposited in the lower region of device 1. The liquid is hereby collected at the lower edge in a type of basin or vat, which can also be inclined. The excess spreading amount is removed via a return flow 11 and led back into the supply container from which the spray nozzles are supplied.

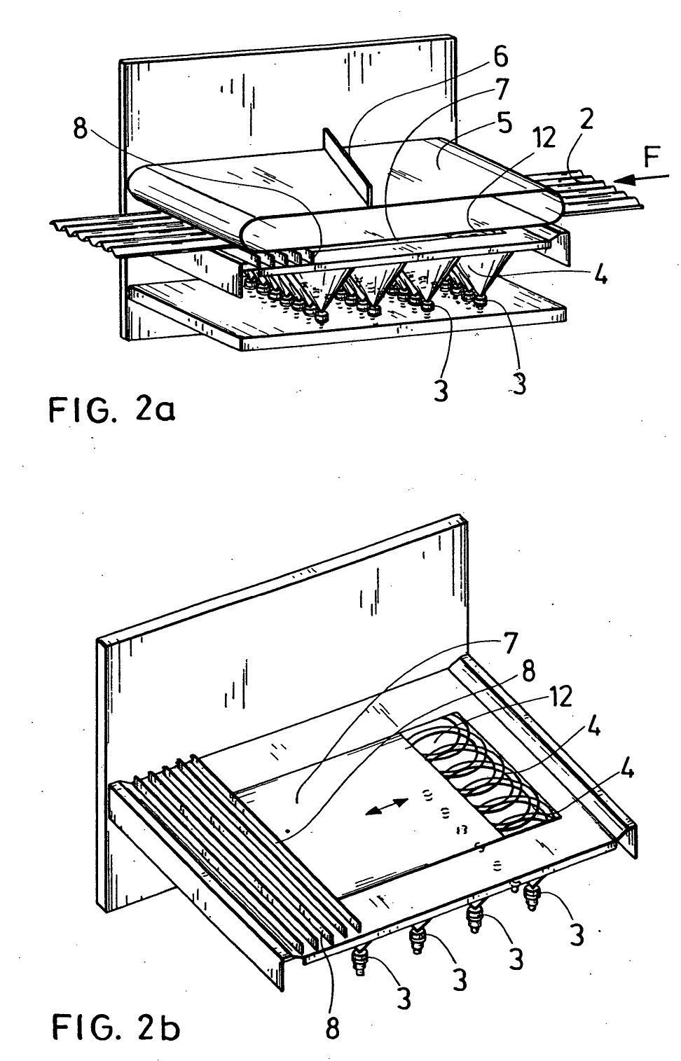

FIGS. 2a and 2b depict diagrammatic, perspective views of the device 1, whereby respective parts were omitted for better illustration. Spray nozzles 3 are arranged regularly spaced below filter tow 2 and create a two-dimensional spray area or spreading area 12. As a result of the constant feed pressure of the plasticizer, an even application of the plasticizer to filter tow 2 is achieved with the aid of spray nozzles 3. Stripping edge 6 on the top side of belt 5 is arranged transverse to the movement direction of belt 5 such that the liquid picked up by belt 5 is fed toward at least one side of the belt and runs down on this and is collected in a collecting basin or vat. As indicated in FIG. 2b, covering sheet 7 can be displaced such that spreading surface 12 can be increased or reduced.

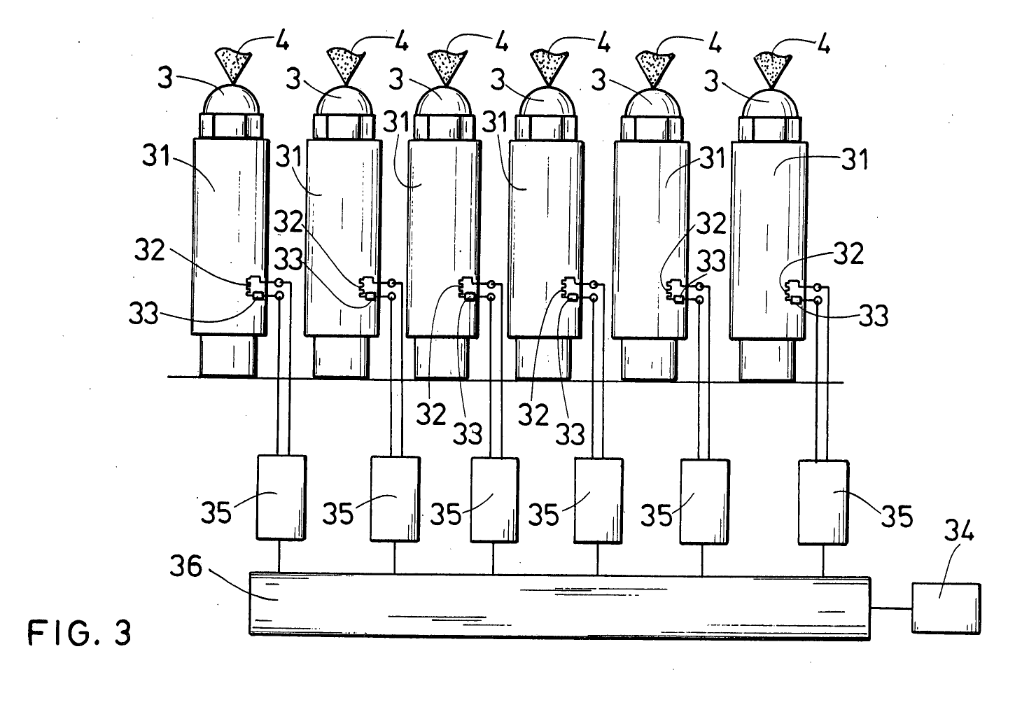

FIG. 3 diagrammatically depicts an arrangement of several spreading nozzles or spray nozzles 3 arranged in a row next to one another. Each spray nozzle 3 is respectively arranged on a cartridge heater 31. Cartridge heater 31 warms the supplied triacetin to a certain temperature, so that the triacetin is subsequently atomized by spray nozzle 3. Each cartridge heater 31 features inside respectively one PTC thermistor 32 and one thermostat 33. PTC thermistor 32 and thermostat 33 are respectively connected to a measuring instrument 35 to determine the electric heating output of cartridge heater 39 or of PTC thermistor 32. Furthermore, measuring instruments 35 are connected to a processor unit 36 in order to compare the measurement values of the heating outputs with one another and to process them.

The warmer the triacetin liquid is that is respectively fed to cartridge heaters 31 and that flows through cartridge heater 31, the lower is the electrical power input of cartridge heater 31 for warming. A warm triacetin liquid thus requires a low power input for heating or warming, whereas a cold triacetin liquid features a high power input.

The heating outputs monitored by measuring instruments 35 are transmitted to processor unit 36, so that a mean value is formed from the transmitted heating outputs as the set value for further or subsequent comparative measurements. A mean value is, e.g., formed in that all values of the determined heating outputs with the exception of the heating outputs with the highest and lowest values are incorporated. If an actual value of a recorded heating output exceeds or falls below the set value by a predetermined range, an alarm is created and displayed. The alarm message is transmitted from processor unit 36 to a display 34. The spreading of triacetin onto the filter material is interrupted if the difference between an actual value and the set value is outside a fairly large tolerance range. In this case, the inlet pipe for triacetin will possibly have to be cleaned or clogged spreading nozzles will have to be replaced, if applicable.

The subject matter of the invention improves the production reliability for spreading triacetin onto a moving filter material strip, since a monitoring of the operation of the spreading elements or the spreading nozzles is carried out. A simple monitoring of the operation of each individual spreading nozzle is thus achieved.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

1 Device
2 Filter tow
3 Spray nozzle
4 Spray cone
5 Belt
6 Stripping edge
7 Covering sheet
8 Barriers
9 Rollers
10 Voltage source
11 Return flow
12 Spreading area
13 Collecting vat
31 Cartridge heater
32 PTC thermistor
33 Thermostat
34 Display
35 Measuring instrument
36 Processor unit
F Conveying direction
V Filter tow preparation instrument

What is claimed:

1. A method for spreading an additive onto a moving filter material web of the tobacco-processing industry, comprising:
warming the additive with at least one heating device;
monitoring a heating output of the at least one heating device; and
spreading the additive with at least one spreading element.

2. The method in accordance with claim 1, wherein the additive is a liquid additive.

3. The method in accordance with claim 1, wherein the at least one heating device comprises multiple heating devices, and the heating outputs of a plurality of the multiple heating devices are monitored.

4. The method in accordance with claim 3, further comprising comparing actual values of the heating outputs to a set value.

5. The method in accordance with claim 4, wherein the set value is identified as a mean value of the heating outputs of the plurality of heating devices.

6. The method in accordance with claim 4, wherein the set value is identified as a mean value of the heating outputs of the plurality of heating devices excluding the maximum heating output and the minimum heating output of the plurality of heating devices.

7. The method in accordance with claim 4, further comprising, in response to detecting a predetermined difference between the actual value of the heating output of one of the multiple heating devices and the set value, at least one of producing and displaying an alarm message.

8. The method in accordance with claim 4, further comprising, in response to detecting a predetermined difference between the actual value of the heating output of one of the multiple heating devices and the set value, interrupting the spreading of the additive.

9. The method in accordance with claim 1, wherein the additive is sprayed onto the filter material web by at least one nozzle.

10. The method in accordance with claim 9, wherein the additive for each nozzle is respectively warmed by one heating device.

11. The method in accordance with claim 1, wherein the additive is warmed by at least one of a PTC thermistor of the heating device and a cartridge heater.

12. The method in accordance with claim 1, wherein the additive comprises triacetin.

13. A device for spreading an additive to a moving filter material web of the tobacco-processing industry, comprising:
a spreading element;
at least one heating device structured and arranged to heat the additive; and
a monitor device structured and arranged to monitor a heating output of the at least one heating device.

14. The device in accordance with claim 13, wherein the additive is a liquid additive.

15. The device in accordance with claim 13, wherein the monitor device comprises a measuring arrangement.

16. The device in accordance with claim 15, wherein the measuring arrangement comprises a plurality of measuring devices structured and arranged to measure the heating outputs.

17. The device in accordance with claim 15, wherein the measuring arrangement comprises at least one of a processor unit and a display.

18. The device in accordance with claim 13, wherein the spreading element comprises spreading devices and the at least one heating device comprises heating devices, such that one heating device is respectively associated with each spreading device.

19. The device in accordance with claim 13, wherein the heating device comprises one of a PTC thermistor and a cartridge heater.

20. The device in accordance with claim 13, wherein the spreading element comprises at least one nozzle.

21. An apparatus for preparing filter material webs of the tobacco-processing industry comprising the device in accordance with claim 13.

22. A process of supplying an additive to a web in the device in accordance with claim 13, comprising:
heating the additive with the at least one heating device composed of a cartridge heater;
monitoring the heating output of the cartridge heater; and
supplying the heated additive to the spreading element.
